(19) United States
(12) Patent Application Publication
(10) Pub. No.: US 2017/0004719 A1
(43) Pub. Date: Jan. 5, 2017

(54) METHOD AND SYSTEM FOR GOAL-ORIENTED LEARNING PLATFORM WITH SEAMLESS INTEGRATION OF INCENTIVES

(71) Applicants: Amey Vishvanath Laud, Brush Prairie, WA (US); Vadim Mostovoi, Essentuki (RU)

(72) Inventors: Amey Vishvanath Laud, Brush Prairie, WA (US); Vadim Mostovoi, Essentuki (RU)

(21) Appl. No.: 15/193,068

(22) Filed: Jun. 26, 2016

Related U.S. Application Data
(60) Provisional application No. 62/185,490, filed on Jun. 26, 2015.

(51) Int. Cl. G09B 7/00; G09B 5/12

(52) U.S. Cl. CPC G09B 7/00; G09B 5/12

(57) ABSTRACT

A method and system for providing a seamless goal based learning platform integrating incentives. The method includes enabling a tutor to customize a first learning goal to be performed in a program and a first incentive to be awarded upon finishing said first learning goal. The method includes enabling a student to create an account with a learning goal and an associated incentive, the incentive is automatically transferred to the student account once the student finishes said learning goal. The method includes monitoring a learning activity status of the student. The method includes automatically generating practice sessions related to a first program. The method enables the student to electronically input responses for each practice session, maintaining the performance data indicative of student's performance on the content, granting the incentive to the user based on the determined performance data, and automatically providing integration with third party websites to redeem incentives.

### CROSS-REFERENCE TO RELATED APPLICATION

The present application is related to and claims the priority benefit of U.S. Provisional Application No. 62/185,490 Filed on Jun. 26, 2015, which is incorporated herein by reference in its entirety.

### FIELD OF THE INVENTION

The present application generally relates to the field of goal-based learning platform on computing devices. Particularly, the application provides a method and system for goal-oriented learning platform with seamless integration of incentives.

### BACKGROUND

Employing better learning methods is essential in ensuring that learning is both regular and effective. New methods of learning have been evolving, so that children learn more regularly and more effectively. With the advent of Internet, learning has become lot easier. Learning systems and associated practice content on each subject are available online. E-learning methods are preferably adopted by children since they provide better accessibility to relevant content on their personal computing devices, such as laptops, tablets and smartphones. Much energy and talent is focused on developing ‘fun’ or ‘interactive’ educational content and systems to attract students to learn or practice. Practice software, such as software designed for improving reading or math, needs to be used regularly to result in improved performance. However, in the practical world, many students lack the motivation or discipline to use such software or to use it regularly enough to be effective. Much e-learning software therefore ends up only being useful in principle, but not effective in practice.

Existing prior art provide educational content on computing devices that employ gamification, virtual rewards or reward points, aimed at making it likelier that children should use such systems. Although this provides an additional draw to using such systems, it is not sufficient to motivate most children to ensure regular usage or to ensure sufficient and dedicated time is spent using such systems. Additionally, as the educational content includes more multimedia and gets interactive, learner's patience and attention span diminishes.

Psychologists and researchers agree that indirect rewards play a significant role in increasing an individual's ability to meet goals. In the context of learning, indirect rewards can serve to increase attentiveness and likelihood in meeting learning goals, especially if learning goals are unambiguous and clearly stated, and if rewards for meeting learning goals are offered fairly, seamlessly and therefore in a consistent manner.

Current on-line learning or feedback systems generally either do not provide initial incentives, or simply provide short term incentives which are not based on any learning goals. Such learning systems do not allow parents to set tasks/goals for their children in order to obtain an incentive. Thus, there is need for e-learning systems that allows teachers/parents to customize learning goals based on skills learned along with associated incentives for each goal.

Another educational platform assigns various learning tasks to children and associates a reward point to each task. The children can accumulate reward points for completing each task and further exchange the reward points with a third party for gifts/rewards. However, children are not rewarded immediately. Moreover, children need to go through various distributors and third party service providers to redeem the reward points. The existing educational platform doesn't seamlessly integrate task accomplishment with reward/gifts that can be redeemed automatically at the platform. Furthermore, none of the state of art provides a goal-based learning platform integrated with consistent monitoring of learning sessions, customization of learning goals, and seamless incentives on achieving learning goals.

In view of the above mentioned background, it is evident that, there is a need for a goal-based learning platform that provides incentives as indirect rewards for achieving learning goals. Further, there exists a need for a learning platform that seamlessly integrates monitoring of learning sessions, customization of learning goals, auto-generation of contents based on children's performance and providing incentives associated with each learning goal. A method and system is desired for goal-oriented learning platform with seamless integration of incentives.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a method and system for goal-based learning platform that provides incentives as indirect rewards for achieving learning goals.

Another objective is to provide a method and system for a goal based learning platform that seamlessly integrates built-in monitoring of learning sessions, customization of learning goals, adaptive auto-generation of contents based on children's performance and further provides incentives associated with each learning goal.

Yet another objective of the present invention is to provide a learning platform that monitors performance of students and adaptively generates content based on the performance of students.

In accordance with one embodiment of the present invention, a method and system 100 enables a tutor to customize a first learning goal to be performed in a program and a first incentive to be awarded upon finishing said first learning goal. The system 100 enables a student to create an account with a learning goal and an associated incentive, wherein once the student finishes said learning goal, the incentive is automatically transferred to the student account. The system 100 monitors a learning activity status of the student, wherein the learning activity status indicates whether the student is learning, making a progress in learning, achieving a milestone in learning, and a performance data of the student. The system 100 automatically generates practice sessions related to a first program, wherein the practice session is generated based on the learning activity status of the student. The system 100 enables the student to electronically input responses for each practice session. The system 100 maintains the performance data indicative of student's performance on the content. The system 100 grants the incentive to the user based on the determined performance data. The system 100 automatically provides integration with third party websites to redeem incentives.

The system 100 further includes a tutor-account database 110 which stores a plurality of Third Party Providers with their respective associated information and tutor IDs. The system 100 includes a user-account database 112 112 which stores a plurality of students with their respective associated information and Student IDs. The system 100 includes an incentive program database 114 which stores a plurality of programs configurable by a respective tutor, each incentive program having a Program ID and a Provider ID, wherein each of said incentive program specifies an incentive in exchange for a Student finishing a session in the incentive Program. The system 100 includes a monitoring unit 116 configured to determine a learning activity status of the student, wherein the learning activity status indicates whether the student is learning, making a progress in learning, achieving a milestone in learning, and a performance data of the student. The system 100 includes a performance determination unit 118 configured to determine an incentive to be rewarded to the student, wherein the incentive provided is determined based on performance data of the student. The system 100 includes a customization unit 120 configured to grant a reward to the user based on the determined learning state, the determined learning activity status, and the determined reward category. The system 100 includes a reward unit 122 configured to communicate with a third party service provider, regarding the incentive to be granted to the student. The reward unit 122 is configured to enable the student to select a gift associated with the incentive from a third party service provider. Further, the system 100 links the third party service provider's payment gateway with bank account information of a tutor. The system 100 enables the student to seamlessly purchase the gift at the goal based learning platform.

The above said method and system is provided for goal-oriented learning platform with seamless integration of incentives but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 is a block diagram illustrating system for goal-oriented learning platform with seamless integration of incentives;

FIG. 2 is an exemplary illustration of a user interface in the goal based learning platform displaying login options, in accordance with one embodiment of the present invention;

FIG. 3 is an exemplary illustration of a user interface in the goal based learning platform displaying account creation options, in accordance with one embodiment of the present invention;

FIG. 4 is an exemplary illustration of a user interface in the goal based learning platform displaying tutor login, in accordance with one embodiment of the present invention;

FIG. 5 is an exemplary illustration of a user interface in the goal based learning platform enabling tutor to provide student information, in accordance with one embodiment of the present invention;

FIG. 6 is an exemplary illustration of a user interface in the goal based learning platform providing student performance data to tutors, in accordance with one embodiment of the present invention;

FIG. 7 is an exemplary illustration of a user interface in the goal based learning platform displaying rewards achieved by a student, in accordance with one embodiment of the present invention;

FIG. 8 is an exemplary illustration of a user interface in the goal based learning platform enabling customization of learning goals, in accordance with one embodiment of the present invention;

FIG. 9 is an exemplary illustration of a user interface in the goal based learning platform enabling customization of learning goals, in accordance with one embodiment of the present invention;

FIG. 10 is an exemplary illustration of a user interface in the goal based learning platform displaying pre-configured templates of learning goals, in accordance with one embodiment of the present invention;

FIG. 11 is an exemplary illustration of a user interface in the goal based learning platform enabling selection of learning skills to be achieved by student, in accordance with one embodiment of the present invention;

FIG. 12 is an exemplary illustration of a user interface in the goal based learning platform displaying student login ID, in accordance with one embodiment of the present invention;

FIG. 13 is an exemplary illustration of a user interface in the goal based learning platform displaying practice sessions for students , in accordance with one embodiment of the present invention;

FIG. 14 is an exemplary illustration of a user interface in the goal based learning platform displaying practice sessions for students, in accordance with one embodiment of the present invention;

FIG. 15 is an exemplary illustration of a user interface in the goal based learning platform displaying practice sessions for students, in accordance with one embodiment of the present invention;

FIG. 16 is an exemplary illustration of a user interface in the goal based learning platform displaying reward redemption for students, in accordance with one embodiment of the present invention;

FIG. 17 is an exemplary illustration of a user interface in the goal based learning platform displaying reward selection, in accordance with one embodiment of the present invention; and

FIG. 18 is an exemplary illustration of a user interface in the goal based learning platform displaying skill selection, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, a method and system 100 for goal-oriented learning platform with seamless integration of incentives is provided. The method and system for goal-based learning platform provides incentives as indirect rewards for achieving learning goals. The method and system for a goal based learning platform that seamlessly integrates built-in monitoring of learning sessions, customization of learning goals, adaptive auto-generation of contents based on children's performance and further provides incentives associated with each learning goal. The method and system provides a learning platform that monitors performance of students and adaptively generates content based on the performance of students.

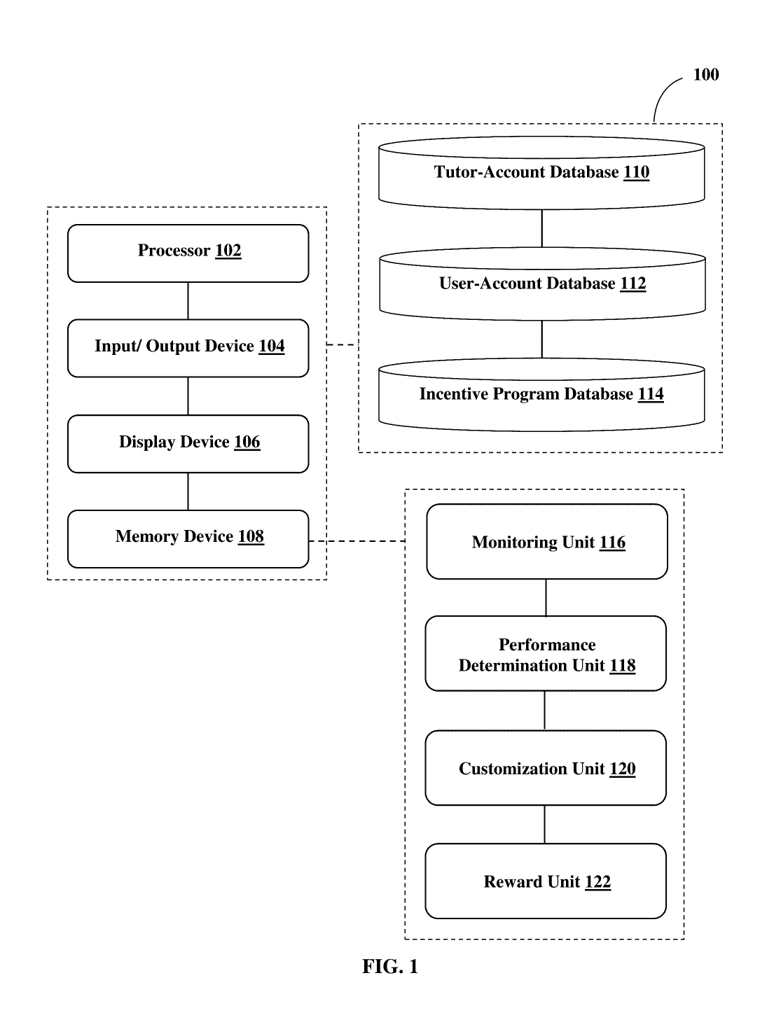

Referring to the FIG. 1 is a block diagram illustrating system for goal-oriented learning platform with seamless integration of incentives. The system 100 for goal based learning platform may include a processor 102, an input/output device 104 operatively coupled to the processor 102, a display device 106 operatively coupled to the processor 102, and a memory device 108 operatively coupled to the processor 102. The memory device 108 may be configured to store instructions to cause the apparatus to enable a tutor to customize a first learning goal to be performed in a program and a first incentive to be awarded upon finishing said first learning goal. The system 100 may be configured to enable a student to create an account with a learning goal and an associated incentive, wherein once the student finishes said learning goal, the incentive may be automatically transferred to the student account. The system 100 may monitor a learning activity status of the student, wherein the learning activity status indicates whether the student is learning, making a progress in learning, achieving a milestone in learning, and a performance data of the student. The system 100 may automatically generates practice sessions related to a first program, wherein the practice session is generated based on the learning activity status of the student. The system 100 may be configured to enable the student to electronically input responses for each practice session. The system 100 may be configured to maintain the performance data indicative of student's performance on the content. The system 100 may be configured to grant the incentive to the user based on the determined performance data. The system 100 may automatically provide integration with third party websites to redeem incentives.

The system 100 may further includes a tutor-account database 110 which stores a plurality of third party providers with their respective associated information and tutor IDs. The system 100 may include a user-account database 112 configured to store a plurality of students with their respective associated information and student IDs. The system 100 may further include an incentive program database 114 configured to store a plurality of programs configurable by a respective tutor, each incentive program having a program ID and a provider ID, wherein each of said incentive program may specify an incentive in exchange for a Student finishing a session in the incentive Program. The system 100 may include a monitoring unit 116 configured to determine a learning activity status of the student, wherein the learning activity status indicates whether the student is learning, making a progress in learning, achieving a milestone in learning, and a performance data of the student. The system 100 may also include a performance determination unit 118 configured to determine an incentive to be rewarded to the student, wherein the incentive provided is determined based on performance data of the student. The system 100 may further include a customization unit 120 configured to grant a reward to the user based on the determined learning state, the determined learning activity status, and the determined reward category. The system 100 may also include a reward unit 122 configured to communicate with a third party service provider, regarding the incentive to be granted to the student. The reward unit 122 may be configured to enable the student to select a gift associated with the incentive from a third party service provider. Further, the system 100 may link the third party service provider's payment gateway with bank account information of a tutor. The system 100 may be configured to enable the student to seamlessly purchase the gift at the goal based learning platform.

In accordance with one embodiment of the present invention, the system 100 may have a user application automatically installable and executable on a computing device. In accordance with one embodiment of the present invention, the performance determination unit 118 may be configured to measure data indicative of the student's performance maintained for each practice session, wherein the data includes at least one of an amount of time required by the student to respond to each problem in the practice session, correctness of response received from the student for each problem, and a level of difficulty associated with each problem.

The present app may comprise of screens designed for parents (assumed by this app to be the default carer) and for children (assumed by the app to be the default learner). To help explain how the present invention works one may divide the following description into two parts. The first part may be meant to explain the use of the app for the parent (parent screens) and the second part to explain the use for the child (child screens).

In accordance with one embodiment of the present invention, the method of providing the seamless goal based learning platform integrating incentives is provided. The method may include enabling a tutor to customize a first learning goal to be performed in a program and a first incentive to be awarded upon finishing said first learning goal. The method may include enabling a student to create an account with a learning goal and an associated incentive, wherein once the student finishes said learning goal, the incentive is automatically transferred to the student account. The method may include monitoring a learning activity status of the student, wherein the learning activity status indicates whether the student is learning, making a progress in learning, achieving a milestone in learning, and a performance data of the student. Further, the method may include automatically generating practice sessions related to a first program, wherein the practice session are generated based on the learning activity status of the student; enabling the student to electronically input responses for each practice session; maintaining the performance data indicative of student's performance on the content; granting the incentive to the user based on the determined performance data; and automatically providing integration with third party websites to redeem incentives.

In accordance with one embodiment of the present invention the step of enabling a tutor to customize a first learning goal may comprise steps of configuring a number of practice sessions to be incorporated in the first learning goal, configuring a time required for each practice session in the first learning goal, and configuring a number of days required to complete the practice sessions. The method may further include determining whether the detected learning activity status is equal to a predetermined learning activity status; and granting an incentive to the student in a predetermined incentive category, when the detected learning activity status is equal to a predetermined learning activity status. The performance data indicative of the student's performance maintained for each practice session includes at least one of an amount of time required by the student to respond to each problem in the practice session; correctness of response received from the student for each problem; and a level of difficulty associated with each problem.

The method may further include providing a wide range of information and practice sessions related to a specific topic; adaptively changing the practice sessions based on the student's learning capability and performance data, wherein the practice session are of varying difficulty levels. The incentive may include one of an authorization of access of functions of a device of the user, a credit to make a purchase online, a credit to make a purchase at retail, a deposit to a bank account, a coupon for an item. The step of automatically providing integration with third party websites to redeem incentives includes enabling the student to select a gift associated with the incentive from the third party website, linking the third party website's payment gateway with bank account information of the tutor; and may enable the student to seamlessly purchase the gift at the goal based learning platform.

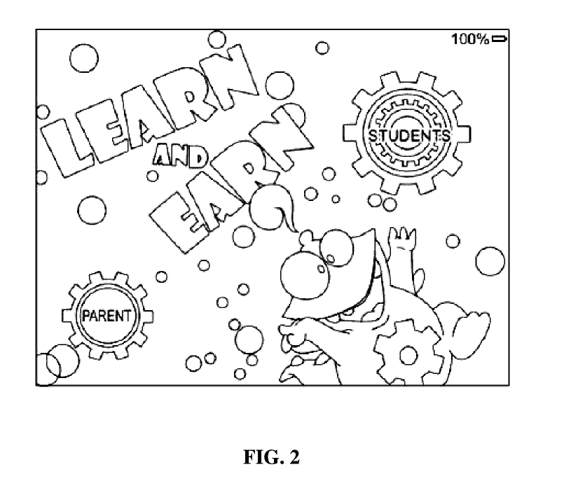

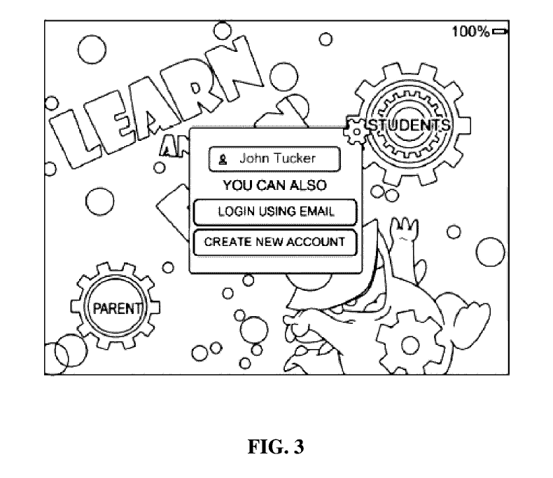

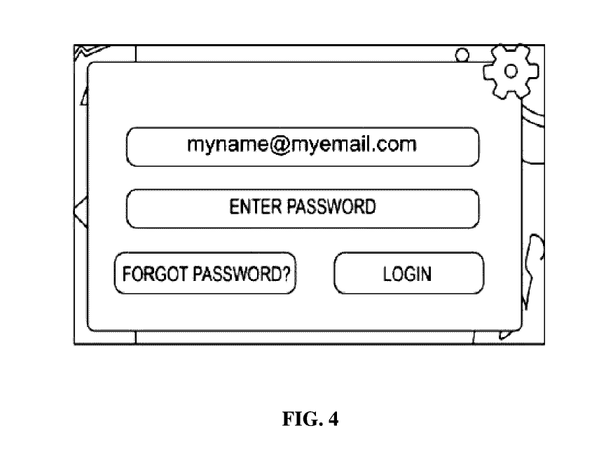

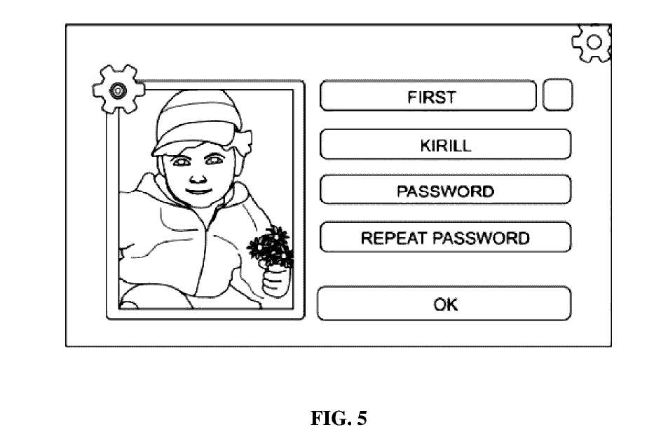

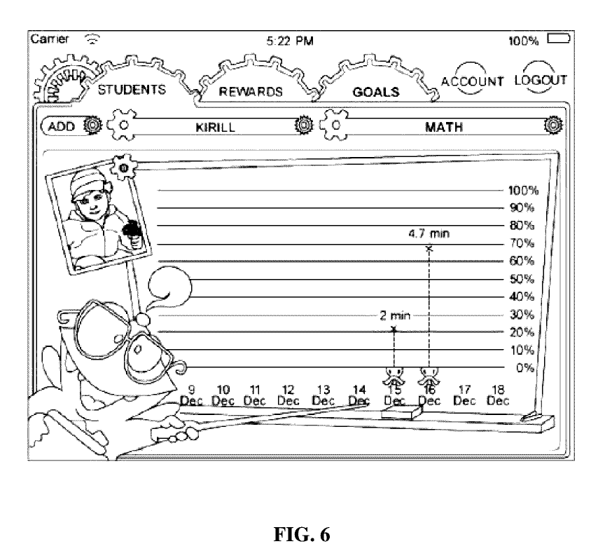

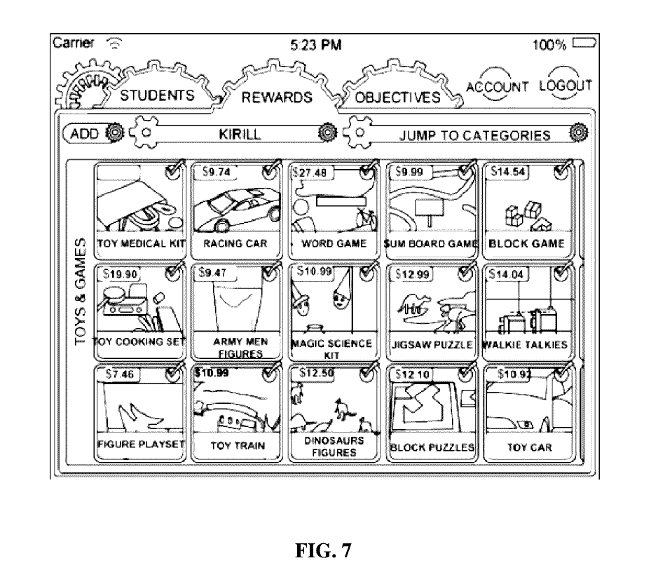

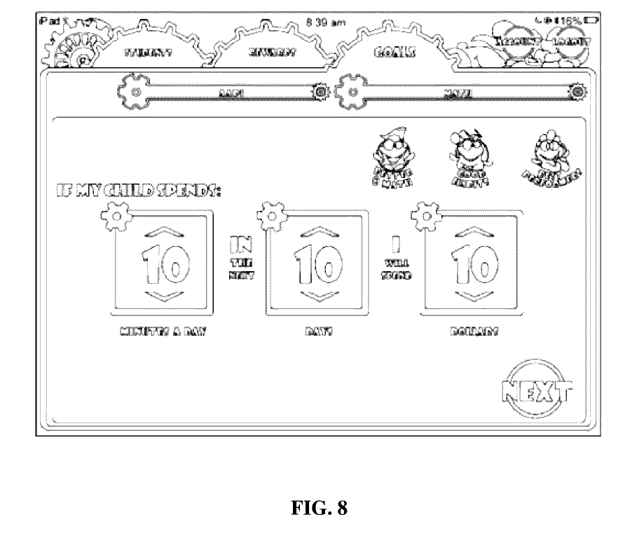

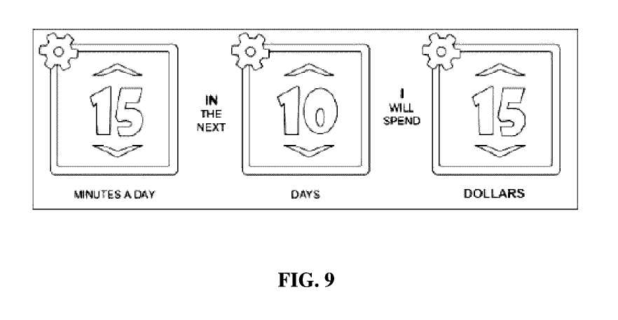

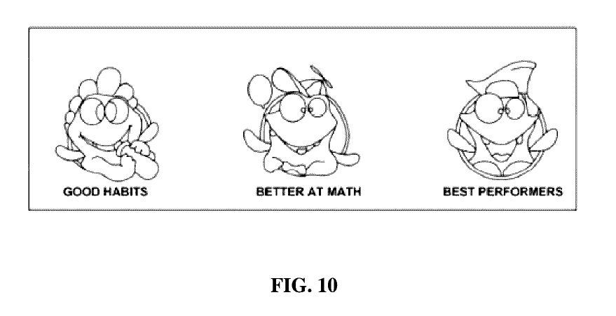

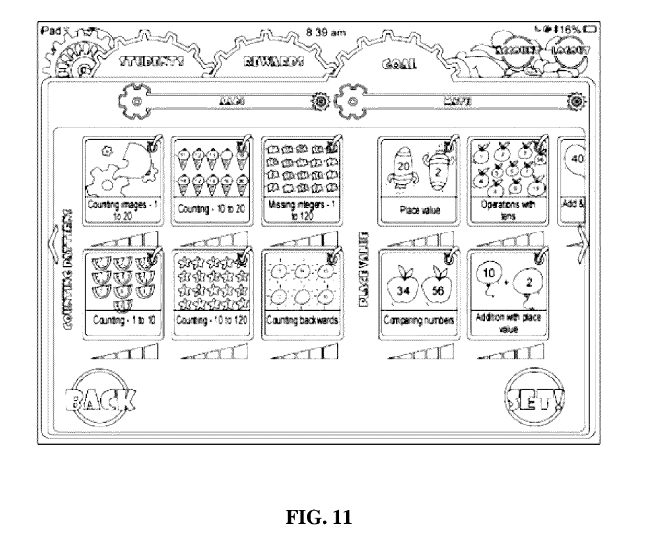

Referring to FIG. 2, upon downloading the app, the app may present logins for parents and children. Referring to FIG. 3, upon first download, a parent may have two options, the first is to login if he already has an account and the second is to create an account if he does not have one. Referring to FIG. 4 and FIG. 5, parent must login to the app by creating a login using their email address as identity and a password. Referring to FIG. 6, may represents Student screen, a parent may now configure the app for each of their children that will be using this app. The Students screen may allow parents to provide specifics for their children by entering their grade in school. In an example, the app is developed for elementary school math, grades 1-6. The Student screen may also allow a parent to monitor the progress of children that have already been using this app, letting them monitor progress on a daily basis and check on rewards and milestones that they have reached along the way. Referring to FIG. 7 may represent the Rewards screen, the parent may be provided with a list of several hundred rewards that they may make available for their child. The curated list of rewards may be provided for each age category and gender (e.g. 6 year old boys have a different list than 6 year old girls). The parent may either choose to allow their child to pick from the entire list or alternately they may deselect specific rewards or rewards categories that they feel are inappropriate for their children. Rewards may be organized by category and show details including the price in the local currency. Parents may also add custom rewards by providing a link to the product from pre-specific online store (e.g. currently support access may be provided to any product from a particular local store in countries that have such stores). Referring to FIG. 8, FIG. 9, FIG. 10 and FIG. 11 may represent the Goals screens. In these screens, the parent may devise a motivational scheme appropriate for their child.

Referring to FIG. 9 the configuration of specific time-bound commitments may be made within the motivational scheme. Using this portion, the parent may indicates (a) a specific amount of time that must be met in a given day, (b) a period of time in terms of days in which the parent expects their child to practice and (c) the budget for the rewards that they would like to tie to this goal. Referring to FIG. 10 alternately, the parent may pick one of the pre-configured schemes, depending on the emphasis that they feel appropriate for their child. Further, according to a good habit scheme, the settings may change to “10 mins practice for 30 days”. So the emphasis of this scheme may inculcate good habits where a child is motivated to do a small amount of practice time (e.g. 10 mins) on a daily basis, but for an extended period of time (e.g. 30 days). Another scheme, such as better at math, the settings may change to “20 mins practice for 10 days”. So the emphasis is for a longer practice (e.g. 20 mins) even though this may be tested over a smaller time period in terms of days. Further, best performers scheme, the settings may change to “20 mins of math, for 30 days in a row”. In this case, targeting those aspiring to be high-performers among children, or parents aspiring as much for their children, the child is tested for both being regular over an extended period in terms of days (e.g. 30 days) and made to do a longer practice per day (e.g. 20 mins). Once a parent may configure this scheme, they may proceed to the next step of the Goals screen, shown under FIG. 11. In this screen, the parent may have the option of selecting specific skills in math that they would like their child to practice for their selected Grade. Alternately, a parent may choose to let their child pick specific skills to practice. Once the parent is done configuring the goal, it is seen as “Set” and a summary of their scheme is presented to the parent, as shown in FIG. 11, and the child is now ready to login and start using the app.

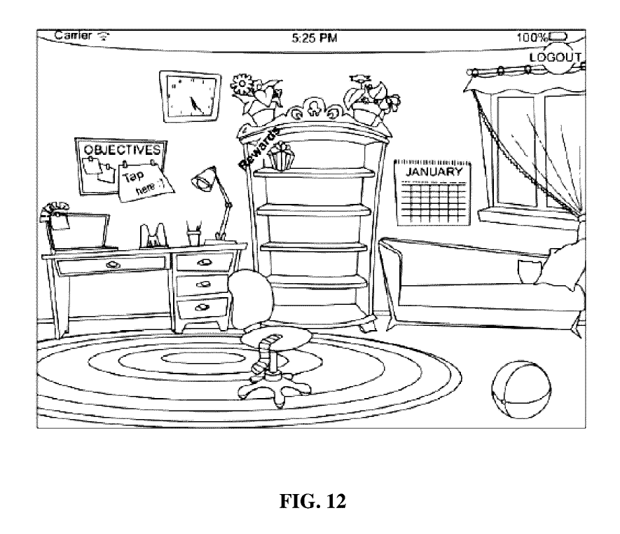

Referring to FIG. 12 upon login, each child may be taken to a “room” that essentially serves as an entry point to each of the screens that the child may use. The room may also have a showcase for rewards that the child has already earned. The child must first make their choice of reward to work towards, although the choice of reward may be changed anytime later. To do this, the child may tap on the Rewards icon in the room screen leading the child to a screen as in FIG. 7. Unlike the list of rewards that was shown to the parent in local currency terms, the rewards shown to the child may be shown in “Days of practice” required. For example, if the parent has devised a scheme where they have committed to a reward of $10 for 10 mins of practice over 10 days, then, a $5 ball will be shown as a reward that may be earned with 5 days of practice and labeled as “5 days to earn”. Similarly, a $8 book is labeled as “8 days to earn”. A child may select any of the available rewards to work towards. Every time they redeem a reward, they may select a new reward to work towards. In case a reward exceeds the budget set by the parent in a given goal, the parent may have to set an additional goal subsequent to the completion of the current goal so that their child is able to earn a reward of their choice. For example, if in the above example, if the child selects a reward that needs 20 days of practice (the current scheme being: 10 mins of practice for 10 days enables a reward of $10), then after completion of the current objective, the parent may have to devise a new goal that may be either similar or unrelated to the first one in terms of its expectations. (e.g. 20 mins of practice for 10 days enables a reward of $10).

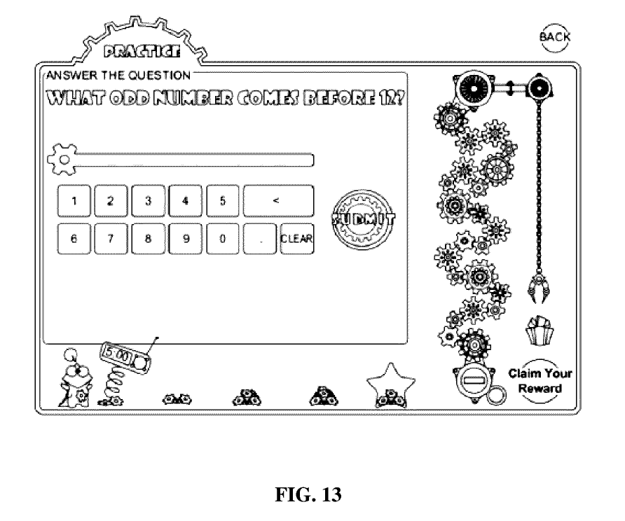

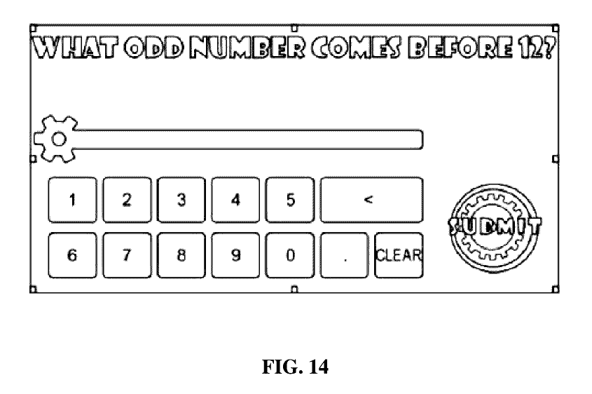

From the Room screen, the child may then click on the Goals button, which leads them to the goals screens as in FIG. 8, FIG. 9, FIG. 10 and FIG. 11. This screen may allow the child to pick a particular skill to practice on a given day. Clicking on a skill may lead to the Practice screens as in FIG. 13 and FIG. 14. The child may use the Practice screen most of the time. In this screen the child may pose a sequence of questions specific to the grade and skill they have selected for practice. The app may accesses questions remotely from our servers. The app may adjust the difficulty of the questions posed depending on the performance of the student based on questions already answered. This may allow the app to pursue an adaptive approach to posing easy versus difficult questions, where question difficulty may be gradually or rapidly increased depending on the child's ability as well as the time taken to answer questions of a given difficulty level. As for the the adaptive rating of difficulty of questions, relatedly, the app may also grade questions based on the average perceived difficulty level of that question based on the average time taken and error rates involved in answering that question. This may allow the app to rate all questions automatically in terms of difficulty level.

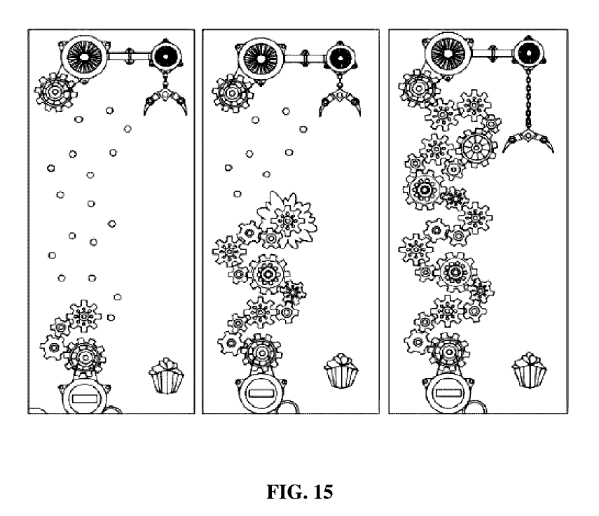

Referring to FIG. 15, in a day's practice, the app may divide available time into four segments (e.g. 5 minutes each in case of a 20 minute daily-practice). In an example, in each time segment, the child may earn a certain number of gears. As questions may be answered, the app mascot nicknamed “Dragua” starts ‘flinging’ these gears into a pulley mechanism, which bears a “clasp” at one end. Below this clasp may be the reward, shown figuratively, that the child is working towards. If a child actually spend all of the allotted time in a given day (e.g. 20 mins of practice), the child may have met their daily goal, thereby enabling the pulley to move closer to the reward. The gears being added the pulley serve as indicator of progress within a given day's practice. On each day of practice, the pulley mechanism may start with zero gears and at the end of the day's practice, having all gears in place ensures that the pulley is activated and moves the clasp closer to the reward. Next to the reward is also an indication of the exact number of days of practice remaining before the child will have earned their selected reward.

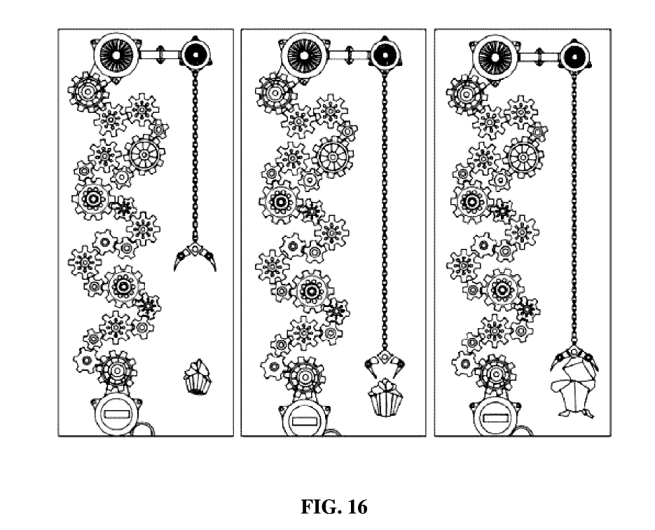

Referring to FIG. 16, on the last day of practice before a reward is due (e.g. Day number 10 out of 10 days of practice that were defined in the Goal), the pulley may move all the way down and the clasp opens the reward to figuratively indicate that they have now earned their reward. This action may take the child once more to the reward page where they may either choose to redeem their already selected reward or alternately, choose a different reward of lower value to redeem. Once the child clicks on the redeem button, the app may send an email to the parent where they must complete the purchase by visiting the link provided in their email. In subsequent versions of the software and depending on regulations in the country, the purchase may be activated instantly when the child clicks on the Redeem button.

The gears activated in each quarter-time segment may differ so that the initial few minutes of practice activate very few gears on the pulley mechanism, with the number of gears activated increasing substantially for each successive period of time spent practicing. As an example where the child is expected to spend 20 minutes of daily practice, the app rewards 2gears for the first 5 minutes of practice, 3 for the next 5 minutes, 5 for the next 5 minutes, 7 for the next 5 minutes, with 3 additional gears rewarded for answering the very last question required to complete the entire 20 minutes of practice. This may serve to encourage children to always meet and to not fall short of daily time expectations, by using a progress indication mechanism that rewards disproportionately to the time spent practicing on a given day and for meeting their daily commitment as per the motivational scheme.

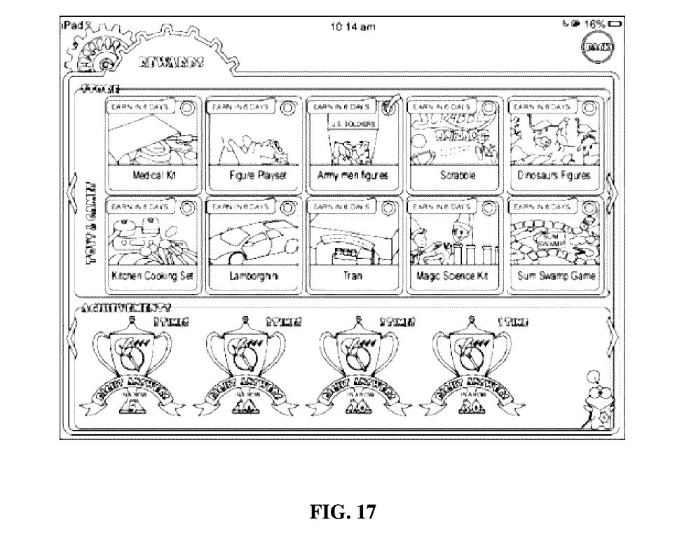

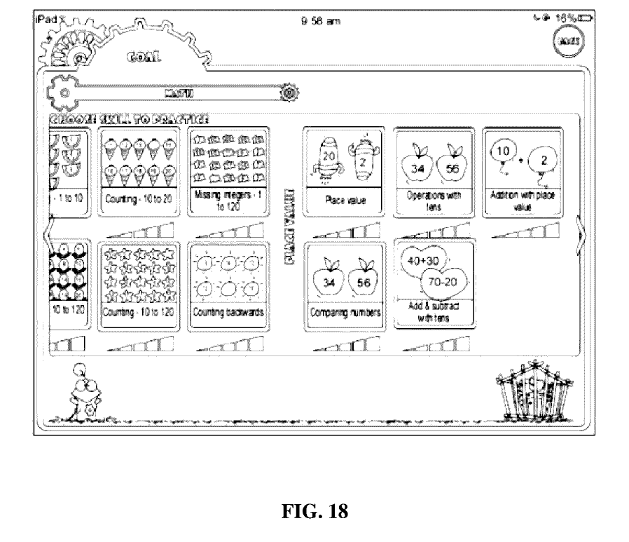

Referring to FIG. 17 is an exemplary illustration of a user interface in the goal based learning platform displaying reward selection. Referring to FIG. 18 is an exemplary illustration of a user interface in the goal based learning platform displaying skill selection, as described.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. A method of providing a seamless goal based learning platform integrating incentives, the method comprising:
enabling a tutor to customize a first learning goal to be performed in a program and a first incentive to be awarded upon finishing said first learning goal;
enabling a student to create an account with a learning goal and an associated incentive,
wherein once the student finishes said learning goal, the incentive is automatically transferred to the student account;
monitoring a learning activity status of the student, wherein the learning activity status indicates whether the student is learning, making a progress in learning, achieving a milestone in learning, and a performance data of the student;
automatically generating practice sessions related to a first program, wherein the practice session is generated based on the learning activity status of the student;
enabling the student to electronically input responses for each practice session;
maintaining the performance data indicative of student's performance on the content;
granting the incentive to the user based on the determined performance data; and
automatically providing integration with third party websites to redeem incentives.

2. The method as claimed in claim 1, wherein the step of enabling a tutor to customize a first learning goal comprises steps of:
configuring a number of practice sessions to be incorporated in the first learning goal;
configuring a time required for each practice session in the first learning goal; and
configuring a number of days required to complete the practice sessions.

3. The method as claimed in claim 1, further comprising:
determining whether the detected learning activity status is equal to a predetermined learning activity status; and
granting an incentive to the student in a predetermined incentive category, when the detected learning activity status is equal to a predetermined learning activity status.

4. The method as claimed in claim 1, wherein the performance data indicative of the student's performance maintained for each practice session includes at least one of:
an amount of time required by the student to respond to each problem in the practice session; correctness of response received from the student for each problem; and
a level of difficulty associated with each problem.

5. The method as claimed in claim 1, further comprising:
providing a wide range of information and practice sessions related to a specific topic;
adaptively changing the practice sessions based on the student's learning capability and performance data, wherein the practice session are of varying difficulty levels.

6. The method as claimed in claim 1, wherein the incentive includes one of an authorization of access of functions of a device of the user, a credit to make a purchase online, a credit to make a purchase at retail, a deposit to a bank account, a coupon for an item.

7. The method as claimed in claim 1, wherein the step of automatically providing integration with third party websites to redeem incentives comprises step of:
enabling the student to select a gift associated with the incentive from the third party website;
linking the third party website's payment gateway with a bank account information of the tutor; and
enabling the student to seamlessly purchase the gift at the goal based learning platform.

8. A system 100 for goal based learning platform, the system 100 comprising:
a processor 102;
an input/output device 104 operatively coupled to the processor 102;
a display device 106 operatively coupled to the processor 102; and
a memory device 108 operatively coupled to the processor 102, the memory device 108 storing instructions to cause the apparatus to:
enable a tutor to customize a first learning goal to be performed in a program and a first incentive to be awarded upon finishing said first learning goal;
enable a student to create an account with a learning goal and an associated incentive,
wherein once the student finishes said learning goal, the incentive is automatically transferred to the student account;
monitor a learning activity status of the student, wherein the learning activity status indicates whether the student is learning, making a progress in learning, achieving a milestone in learning, and a performance data of the student;
automatically generate practice sessions related to a first program, wherein the practice session is generated based on the learning activity status of the student;
enable the student to electronically input responses for each practice session;
maintain the performance data indicative of student's performance on the content;
grant the incentive to the user based on the determined performance data; and
automatically provide integration with third party websites to redeem incentives.

9. The system 100 as claimed in claim 8, further comprising:
a tutor-account database 110 which stores a plurality of Third Party Providers with their respective associated information and tutor IDs;
a user-account database 112 which stores a plurality of students with their respective associated information and Student IDs;
an incentive program database 114 which stores a plurality of programs configurable by a respective tutor, each incentive program having a Program ID and a Provider ID,
wherein each of said incentive program specifies an incentive in exchange for a Student finishing a session in the incentive Program;
a monitoring unit 116 configured to determine a learning activity status of the student,
wherein the learning activity status indicates whether the student is learning, making a progress in learning, achieving a milestone in learning, and a performance data of the student;
a performance determination unit 118 configured to determine an incentive to be rewarded to the student, wherein the incentive provided is determined based on performance data of the student;
a customization unit 120 configured to grant a reward to the user based on the determined learning state, the determined learning activity status, and the determined reward category.

10. The system 100 as claimed in claim 8, further comprising a reward unit 122 configured to communicate with a third party service provider, regarding the incentive to be granted to the student.

11. The system 100 as claimed in claim 10, wherein the reward unit 122 is configured to:
enable the student to select a gift associated with the incentive from a third party service provider;
link the third party service provider's payment gateway with a bank account information of a tutor; and
enable the student to seamlessly purchase the gift at the goal based learning platform.

12. The system 100 as claimed in claim 8, wherein said system 100 has a user application automatically installable and executable on a computing device.

13. The system 100 as claimed in claim 8, wherein performance determination unit 118 is configured to measure data indicative of the student's performance maintained for each practice session, wherein the data includes at least one of:
an amount of time required by the student to respond to each problem in the practice session; correctness of response received from the student for each problem; and
a level of difficulty associated with each problem.
